(19) United States
(12) Patent Application Publication
(10) Pub. No.: US 2010/0174430 A1
(43) Pub. Date: Jul. 8, 2010

(54) AUTOMOTIVE BRAKING CONTROL APPARATUS AND METHOD THEREOF

(75) Inventor: Yoshiaki Irie, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/663,368

(22) PCT Filed: Jun. 3, 2008
(86) PCT No.: PCT/IB08/01410

§ 371 Date: Dec. 7, 2009

(30) Foreign Application Priority Data
Jun. 6, 2007 (JP) 2007-150422

(51) Int. Cl. B60W 20/00; B60W 10/06; B60W 10/08; B60W 10/18; B60W 30/18; B60T 1/10

(52) U.S. Cl. 701/22; 701/70; 701/29; 903/904; 903/947

(57) ABSTRACT

An HV-ECU includes a regenerative braking control unit that controls a regenerative braking system based on the target regenerative braiding force indicated by a signal received from a brake ECU, a regeneration stop timing determination unit that determines a regeneration stop timing, and a regenerative braking stop unit that stops the regenerative braking system when the regeneration stop timing determination unit determines that the regeneration stop timing has been reached.

### BACKGROUND OF THE INVENTION

1. Field of the Invention

The invention relates generally to an automotive braking control apparatus and a method of controlling an automotive braking control apparatus, and more specifically to an automotive braking control apparatus and a method of controlling an automotive braking control apparatus that controls a regenerative brake system and a friction brake system based on the amount by which an operating member is operated by a driver.

2. Description of the Related Art

In recent years, there has been proposed a hybrid vehicle including an engine that outputs torque by burning a fuel therein and an electric motor that outputs torque using electric power supplied thereto. The hybrid vehicle travels using the torque transferred from the engine and/or the electric motor to wheels. In such hybrid vehicle, whether the electric motor is driven or stopped is controlled depending on the driving conditions. Thus, whether to use only the torque from the electric motor or the torque from both the engine and the electric motor to drive the wheels is determined depending on the driving conditions. The electric motor is driven by electric power accumulated in a battery. When the energy in the battery is depleted, the engine is driven to charge the battery. Furthermore, a regenerative brake system is employed in such hybrid vehicle. With the regenerative brake system, when a braking operation is performed in response to depression of a foot brake, the kinetic energy of the vehicle is converted into electric energy by operating the electric motor as a generator, and the electric energy is recovered in the battery for reuse (for example, see Japanese Patent Application Publication No. 08-33114 (JP-A-08-33114)).

FIG. 7 is a graph showing the braking force generated by a hydraulic brake system and the regenerative braking force generated by an electric motor during a braking operation preformed in response to depression of a foot brake of a hybrid vehicle according to a related technology. In FIG. 7, the shaded region represents the regenerative braking force generated by the electric motor, and the other region represents the braking force generated by the hydraulic brake system.

As shown in FIG. 7, if a large braking force is required, both the regenerative braking force generated by the electric motor and the braking force generated by the hydraulic brake system are used. On the other hand, if only a small braking force is required, the regenerative braking force generated by the electric motor is used in most of the operating region, and is replaced with the braking force generated by the hydraulic brake system shortly before the vehicle stops (for example, between approximately 13 km/h and approximately 7 km/h).

The following problems 1) to 3) may occur, because the regenerative braking force is replaced with the braking force generated by the hydraulic brake system shortly before the vehicle stops as described above. 1) In the section labeled “a” in FIG. 7, although energy regeneration may be available, a regenerative braking operation is stopped, which hinders enhancement of the fuel efficiency. 2) The response to the control differs between the electric motor and the hydraulic brake system, and, generally, the hydraulic brake system is slower in the response to the control than the electric motor, which may cause fluctuations in G forces. 3) The hydraulic pressure, when the regenerative braking force is replaced with the hydraulic braking force, is set based on a coefficient of friction μ of a brake pad, which varies greatly. Therefore, it is difficult to apply an appropriate hydraulic pressure. As a result, the G forces may fluctuate due to variation in the coefficient of friction μ of the brake pad.

Furthermore, some hybrid vehicles according to related technologies include a system in which an HV-ECU that controls a drive system and a brake ECU that controls a brake system are connected to each other via, for example, a controller area network (CAN). The response to a control is slower in the CAN communication employed in this system than in the serial communication. When the brake ECU is configured to determine whether or not to stop a regeneration braking operation and output a regeneration stop command to the HV-ECU if it is determined that the regeneration braking operation should be stopped, the HV-ECU receives the regeneration stop command that is transmitted from the brake ECU via the CAN communication and then outputs the regeneration stop command to the motor ECU. Therefore, there is a time lag between when the brake ECU determines that the vehicle is stopping and when the HV-ECU outputs the regeneration stop command to the motor ECU. However, if the brake ECU outputs the regeneration stop command to the HV-ECU immediately before the vehicle stops (or, at the same time that the vehicle stops) in order to regenerate as much energy as possible, there is a possibility that output of a regenerative torque (negative torque) will continue even after the vehicle stops, which may cause an unintentional backward movement of the vehicle.

### SUMMARY OF THE INVENTION

The invention provides an automotive braking control apparatus and a method of controlling an automotive braking control apparatus that controls a regenerative braking system and a friction braking system, wherein a drive system control unit receives a signal indicating a target regenerative braking force from a brake system control unit and controls the regenerative braking system, the automotive braking control apparatus making it possible to regenerate the largest possible energy without causing an unintentional backward movement of a vehicle by preventing a slow response to a control due to communication, which is likely to occur when the regenerative braking system is stopped.

A first aspect of the invention relates to an automotive braking control apparatus that controls a regenerative braking system and a friction braking system based on an amount by which an operating member is operated by a driver to apply a brake. The automotive braking control apparatus includes a brake system control unit that controls a brake system, and a drive system control unit that controls a drive system. The brake system control unit includes a target braking force calculation unit that sets a target braking force based on the amount by which the operating member is operated by the driver, and a regenerative braking force/friction braking force allocation calculation unit that allocates the target braking force between a target regenerative braking force and a target friction braking force based on driving conditions of a vehicle, and outputs a signal indicating the allocated target regenerative braking force to the drive system control unit. The drive system control unit includes a regenerative braking control unit that controls the regenerative braking system based on the target regenerative braking force indicated by the signal received from the brake system control unit, a regeneration stop timing determination unit that determines a regeneration stop timing based on the vehicle driving conditions, and a regenerative braking stop unit that stops the regenerative braking system.

In the first aspect of the invention, the regeneration stop timing determination unit may determine that the regeneration stop timing has been reached when a rotational speed of an electric motor is equal to or lower than a predetermined value.

In the first aspect of the invention, the regenerative braking stop unit may stop the regenerative braking system when the regeneration stop timing determination unit determines that the regeneration stop timing has been reached.

In the first aspect of the invention, the brake system control unit and the drive system control unit may be connected to an in-vehicle LAN, and perform data communication using the in-vehicle LAN.

A second aspect of the invention relates to a control method for an automotive braking control apparatus that controls a regenerative braking system and a friction braking system based on an amount by which an operating member is operated by a driver to apply a brake. The automotive braking control apparatus includes a brake system control unit that controls a brake system, and a drive system control unit that controls a drive system. According to the control method, in the brake system control unit, a target braking force is set based on the amount by which the operating member is operated by the driver, and the target braking force is allocated between a target regenerative braking force and a target friction braking force based on driving conditions of a vehicle and a signal indicating the allocated target regenerative braking force is output to the drive system control unit. Further, in the drive system control unit, a control is executed over the regenerative braking system based on the target regenerative braking force indicated by the signal received from the brake system control unit, a regeneration stop timing is determined based on the driving conditions of the vehicle, and a control is executed to stop the regenerative braking system.

According to the aspect of the invention described above, the automotive braking control apparatus, which controls the regenerative braking system and the friction braking system based on the amount by which the operating member is operated by a driver to apply a brake, includes the brake system control unit that controls the brake system and the drive system control unit that controls the drive system. The brake system, control unit includes the target braking force calculation unit that sets the target braking force based on the amount by which the operating member is operated by the driver, and the regenerative braking force/friction braking force allocation calculation unit that allocates the target braking force between the target regenerative braking force and the target friction braking force based on the driving conditions of the vehicle, and outputs a signal indicating the allocated target regenerative braking force to the drive system control unit. The drive system control unit includes the regenerative braking control unit that controls the regenerative braking system based on the target regenerative braking force indicated by the signal received from the brake system control unit, the regeneration stop timing determination unit that determines the regeneration stop timing based on the vehicle driving conditions, and the regenerative braking stop unit that stops the regenerative braking system. Therefore, the drive system control unit determines an appropriate regeneration stop timing and stops the regenerative braking system at the appropriate timing. Accordingly, there is provided the automotive braking control apparatus which makes it possible to regenerate the largest possible energy without causing an unintentional backward movement of the vehicle by preventing a slow response to a control due to communication, which is likely to occur when the regenerative braking system is stopped.

### BRIEF DESCRIPTION OF THE DRAWINGS

The foregoing and further features and advantages of the invention will become apparent from the following description of an example embodiment with reference to the accompanying drawings, wherein like numerals are used to represent like elements and wherein:

FIG. 1 is a view schematically showing the structure of a hybrid vehicle including an automotive braking control apparatus according to an embodiment of the invention;

FIG. 2 is a view schematically showing the structure of a hydraulic brake system within the automotive braking control apparatus according to the embodiment of the invention;

FIG. 3 is a schematic control block diagram for a hydraulic brake according to the embodiment of the invention;

FIG. 4 is a functional block diagram for a brake ECU and an HV-ECU;

FIG. 5 is a flowchart illustrating the control routine executed by the HV-ECU during a braking operation;

FIG. 6 is a graph showing the braking force generated by a hydraulic brake system and the regenerative braking force generated by an electric motor during the braking operation preformed in response to depression of a foot brake of the hybrid vehicle according to the embodiment of the invention; and

FIG. 7 is a graph showing the braking force generated by a hydraulic brake system and the regenerative braking force generated by an electric motor during a braking operation preformed in response to depression of a foot brake of a hybrid vehicle according to a related technology.

### DETAILED DESCRIPTION OF EMBODIMENT

An automotive braking control apparatus according to an embodiment of the invention will be described below in detail with reference to the accompanying drawings. Note that, the invention is not limited to this embodiment. Furthermore, the elements in the following embodiment include elements which can easily be conceived by one skilled in the art, or elements which are substantially the same.

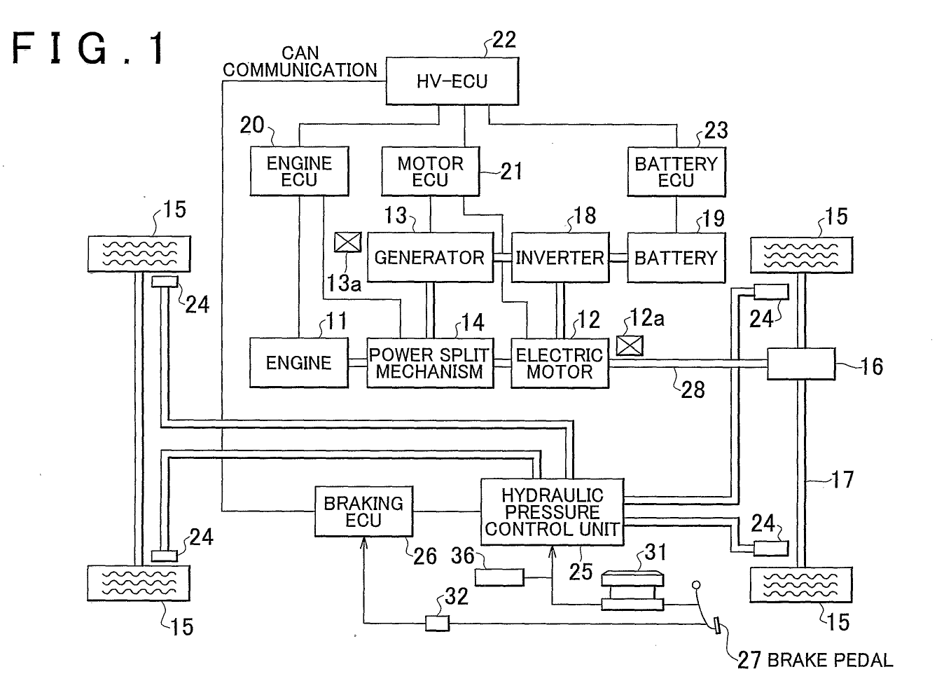

FIG. 1 is a view schematically showing the structure of a hybrid vehicle including an automotive braking control apparatus according to an embodiment of the invention.

As shown in FIG. 1, the hybrid vehicle including the automotive braking control apparatus according to the embodiment of the invention is provided with an engine 11 and an electric motor 12 as drive power sources. Further, the hybrid vehicle is provided with a generator 13 that generates electric power using the drive power supplied from the engine 11. The engine 11, the electric motor 12, and the generator 13 are connected to each other via a power split mechanism 14. This power split mechanism 14 distributes the drive power output from the engine 11 between the generator 13 and drive wheels 15, transfers the drive power output from the electric motor 12 to the drive wheels 15, and functions as a transmission that changes the speed of rotation which is transferred via a propeller shaft 28, a speed reducer 16, and a drive shaft 17 to the drive wheels 15.

The electric motor 12 is an alternating current synchronous motor, and is driven by alternating current power. An inverter 18 converts the direct current power accumulated in a battery 19 to the alternating current power, and then supplies the alternating current power to the electric motor 12. Also, the inverter 18 converts the alternating current power generated by the generator 13 to the direct current power and supplies the direct current power to the battery 19. The generator 13 basically has the same structure as that of the electric motor 12, and is therefore structured as an alternating current synchronous motor. In this case, the electric motor 12 mainly functions as a motor that outputs drive power, and the generator 13 mainly functions as a generator that generates electric power using the drive power supplied from the engine 11.

Although the electric motor 12 mainly functions as a motor that generates drive power, it can function as a generator that generates electric power using rotation of the drive wheels 15 (electric regeneration). At this time, regenerative braking force is applied to the drive wheels 15. Using the regenerative braking force together with the braking force generated in response to depression of a foot brake and the engine braking force, the vehicle can be slowed down or stopped. On the other hand, although the generator 13 mainly functions as a generator that generates electric power using the drive power output from the engine 11, it can function as an electric motor that is driven using the electric power supplied from the battery 19 via the inverter 18.

The engine 11 is provided with a crank position sensor (not shown) that detects the piston position and the engine rotational speed, and that transmits signals indicating the detection results to an engine ECU 20. Furthermore, the electric motor 12 and the generator 13 are provided with a rotational speed sensor 12a and a rotational speed sensor 13a, respectively, which detect the rotational speed and the rotational position and output signals indicating the detection results to an HV-ECU (drive system control unit) 22.

The aforementioned various controls in a hybrid vehicle are executed by a plurality of electronic control units (ECUs). The combination of the operation using the drive power from the engine 11 and the operation using the drive power from the electric motor 12, which is specific to a hybrid vehicle, is comprehensively controlled by the HV-ECU 22. The HV-ECU 22 includes a CPU, a memory and the like, and controls a drive system by executing a control program stored therein. Serial connection is established between the HV-ECU 22 and each of the engine ECU 20, a motor ECU 21, and a battery ECU 23 that controls the battery 19. The HV-ECU 22 determines the allocation of the drive power that should be output between the engine 11 and the electric motor 12, and transmits a control command to the engine ECU 20 to control the engine 11 and a control command to the motor ECU 21 to control the electric motor 12 and generator 13.

Furthermore, the engine ECU 20 transmits the information concerning the engine 11 to the HV-ECU 22, and transmits the information concerning the electric motor 12 and the generator 13 to the HV-ECU 22. The battery ECU 23 monitors the state of charge (SOC) of the battery 19, and outputs a charge request command to the HV-ECU 22 if the SOC is insufficient. Upon reception of the charge request command, the HV-ECU 22 executes a control for causing the generator 13 to generate electric power in order to charge the battery 19.

Furthermore, the vehicle is provided with hydraulic brakes (friction brakes) 24 that correspond to the respective drive wheels 15. Each of the hydraulic brakes 24 is supplied with a prescribed braking hydraulic pressure that is set by a hydraulic pressure control unit 25. The HV-ECU 22 is connected via a CAN (in-vehicle LAN) to a brake ECU (brake system control unit) 26 that controls the hydraulic pressure control unit 25. The brake ECU 26 sets a target braking force depending on the amount by which a brake pedal 27 is operated, and transmits a signal indicating a target regenerative braking force to the HV-ECU 22. The HV-ECU 22 transmits a signal indicating the target regenerative braking force to the motor ECU 21, and the motor ECU 21 controls a regenerative brake system and transmits a signal indicating a result value, in other words, a signal indicating the actually generated regenerative braking force, to the HV-ECU 22. The brake ECU 26 subtracts the actually generated regenerative braking force from the target braking force to determine a target hydraulic braking force, and controls the hydraulic brakes 24 based on this target hydraulic braking force.

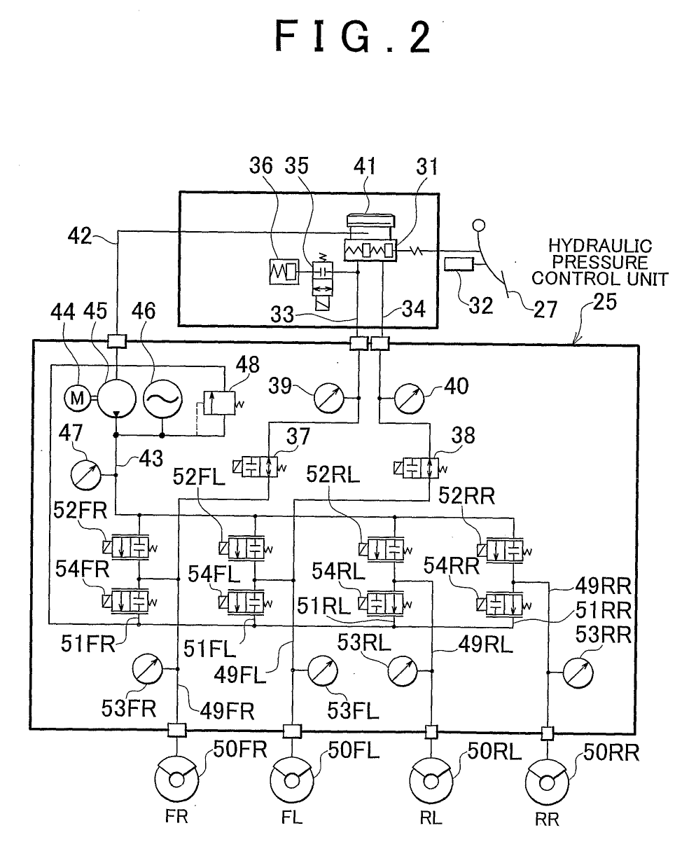

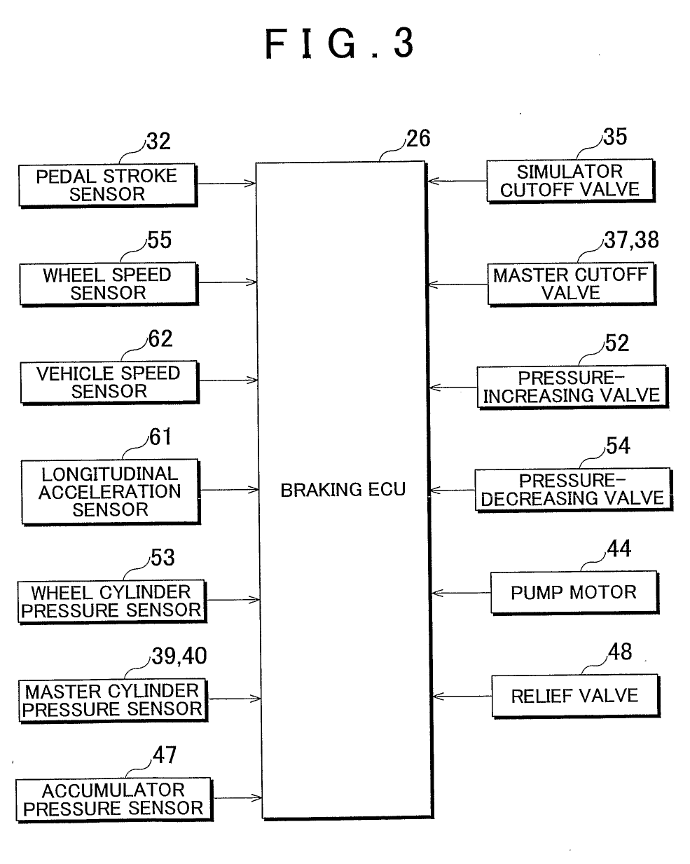

The structure of the hydraulic brakes 24 of the automotive braking control apparatus according to the embodiment of the invention will be described below in detail on the assumption that the automotive braking control apparatus is mounted in the hybrid vehicle having the aforementioned structure. FIG. 2 is a view schematically showing the structure of a hydraulic brake system within the automotive braking control apparatus according to the embodiment of the invention. FIG. 3 is a schematic control block diagram for the hydraulic brake 24 according to the embodiment of the invention.

The hydraulic brakes 24 of the automotive braking control apparatus according to the embodiment of the invention is applied to an electronic control brake system that is able to electronically execute an Antilock Brake System (ABS) control for preventing locking of the drive wheels 15 and an Electronic Braking-force Distribution (EBD) control for adjusting the braking force distribution between the drive wheels 15. The electronic control brake system is able to execute a regular braking control for applying the braking force to each of the drive wheels 15 based on the operating force applied by the driver, without performing the EBD control and the ABS control. The electronic control brake system may be configured to execute only one of the EBD control and the ABS control, or to execute neither the EBD control nor the ABS control.

As shown in FIG. 2 and FIG. 3, a master cylinder 31, which pressurizes the hydraulic fluid in response to the operation of the brake pedal 27 performed by the driver, is connected to the brake pedal 27, and a pedal stroke sensor 32, which detects the amount by which the brake pedal 27 is depressed, that is, the pedal stroke, is connected to the brake pedal 27.

Two hydraulic pressure supply conduits 33 and 34 are connected to the master cylinder 31. A stroke simulator 36 is connected to the hydraulic pressure supply conduit 33 via a normally-open simulator cutoff valve 35. The stroke simulator 36 generates a pedal stroke corresponding to the operating force applied to the brake pedal 27 by the driver. The hydraulic pressure supply conduits 33 and 34 are provided with normally-closed master cutoff valves 37 and 38, respectively. The hydraulic pressure supply conduits 33 and 34 are also provided with and master cylinder pressure sensors 39 and 40 that detect the hydraulic pressures in the hydraulic pressure supply conduits 33 and 34, respectively. The master cylinder pressure sensors 39 and 40 are positioned upstream of the master cutoff valves 37 and 38 (i.e., arranged at positions close to the master cylinder 31).

A hydraulic pressure discharge conduit 42 is connected to a reservoir 41 for the master cylinder 3. A hydraulic pump 45 that is driven by a pump motor 44 is provided at a middle portion of a hydraulic pressure supply conduit 43 that branches off from the hydraulic pressure discharge conduit 42, and an accumulator 46 that accumulates the hydraulic pressure that is boosted by driving the hydraulic pump 45 is connected to the hydraulic pressure supply conduit 43. Furthermore, an accumulator pressure sensor 47, which detects the pressure inside the accumulator 46, is connected to a middle portion of the hydraulic pressure supply conduit 43. In addition, a relief valve 48 is provided between the hydraulic pressure supply conduit 43 and the hydraulic pressure discharge conduit 42. The relief valve 48 returns the accumulated hydraulic fluid to the reservoir 41 when the hydraulic pressure in the hydraulic pressure supply conduit 43 becomes excessively high.

The hydraulic pressure supply conduit 43 branches off into four hydraulic pressure supply branch conduits 49FR, 49FL, 49RL and 49RR which are connected to wheel cylinders 50FR, 50FL, 50RL and 50RR, respectively, that drive the hydraulic brakes 24 (refer to FIG. 1) provided for the respective drive wheels 15. Similarly, the hydraulic pressure discharge conduit 42 branches off into four hydraulic pressure discharge branch conduits 51FR, 51FL, 51RL and 51RR which are connected to the wheel cylinders 50FR, 50FL, 50RL and 50RR, respectively.

Electromagnetically-driven pressure-increasing valves 52 (52FR, 52FL, 52RL and 52RR) are provided at positions (positions on the hydraulic pump 45 side) upstream of the middle portions of the hydraulic pressure supply branch conduits 49FR, 49FL, 49RL and 49RR, to which the hydraulic pressure discharge branch conduits 51FR, 51FL, 51RL and 51RR are connected, respectively. Wheel cylinder pressure sensors 53 (53FR, 53FL, 53RL and 53RR), which detect the hydraulic pressures supplied to the wheel cylinders 50FR, 50FL, 50RL and 50RR, are provided at positions (positions on the wheel cylinder 50FR, 50FL, 50RL and 50RR side) downstream of the middle portions of the hydraulic pressure supply branch conduits 49FR, 49FL, 49RL and 49RR, to which the hydraulic pressure discharge branch conduits 51FR, 51FL, 51RL and 51RR are connected, respectively. Furthermore, electromagnetically-driven pressure-decreasing valves 54 (54FR, 54FL, 54RL and 54RR) are provided at positions (positions on the reservoir 41 side) downstream of the middle portions of the hydraulic pressure discharge branch conduits 51FR, 51FL, 51RL and 51RR, to which the hydraulic pressure supply branch conduits 49FR, 49FL, 49RL and 49RR are connected, respectively.

Furthermore, the hydraulic pressure supply branch conduits 49FR, 49FL, 49RL and 49RR are connected via the master cutoff valves 37 and 38 to the hydraulic pressure supply conduits 33 and 34, at positions downstream of the electromagnetically-driven pressure-increasing valves 52FR, 52FL, 52RL and 52RR, respectively. Thus, the master cylinder 31 is connected to the wheel cylinders 50FR, 50FL, 50RL and 50RR via the master cutoff valves 37 and 38. Furthermore, the four drive wheels 15 are equipped with wheel speed sensors 55 that detect the rotational speeds of the corresponding drive wheels.

The brake ECU 26 includes a CPU, a memory and the like, and executes a braking control by executing a braking control program stored therein. More specifically, signals indicating the hydraulic pressures detected by the master cylinder pressure sensors 39 and 40, the hydraulic pressure detected by the accumulator pressure sensor 47, and the hydraulic pressures detected by the wheel cylinder pressure sensors 53 (53FR, 53FL, 53RL and 53RR) are input in the brake ECU 26. Furthermore, signals indicating the pedal stroke detected by the pedal stroke sensor 32 and the wheel speeds detected by the wheel speed sensors 55 are input in the brake ECU 26. Then, the brake ECU 26 controls the simulator cutoff valve 35, master cut off valves 37 and 38, electromagnetically-driven pressure-increasing valves 52 (52FR, 52FL, 52RL and 52RR), the electromagnetically-driven pressure-decreasing valves 54 (54FR, 54FL, 54RL and 54RR), the pump motor 44, and the relief valve 48.

Therefore, the master cutoff valves 37 and 38 are normally closed and the simulator cutoff valve 35 is normally open, and the master cylinder 31 generates hydraulic pressure corresponding to the operation amount of the brake pedal 27 when the driver depresses the brake pedal 27. Meanwhile, because a portion of the hydraulic fluid flows from the hydraulic pressure supply conduit 33 via the simulator cutoff valve 35 into the stroke simulator 36, the operation amount of the brake pedal 27 is adjusted based on the depressing force applied onto the brake pedal 27. That is, the pedal operation amount (pedal stroke) corresponding to the depressing force is achieved. The pedal stroke is detected by the pedal stroke sensor 32. Alternatively, the pedal stroke may be calculated based on the hydraulic pressures detected by the master cylinder pressure sensors 39 and 40. If the detected pedal stroke does not match the calculated pedal stroke, it is determined that at least one of the sensors 32, 39 and 40, the master cylinder 31 and the hydraulic pressure supply conduits 33 and 34 is malfunctioning.

The brake ECU 26 sets the target hydraulic braking force based on the detected pedal stroke and the regenerative braking force, determines the target hydraulic braking forces that are distributed to the respective drive wheels 15, and sets the target hydraulic pressures that are supplied to the respective wheel cylinders 50FR, 50FL, 50RL and 50RR. At this time, a predetermined hydraulic pressure is accumulated in the accumulator 46. However, if the hydraulic pressure detected by the accumulator pressure sensor 47 is below a prescribed hydraulic pressure lower limit, the pressure is increased by driving the pump motor 44 to run the hydraulic pump 45. On the other hand, if the hydraulic pressure far exceeds a prescribed hydraulic pressure upper limit, the relief valve 48 opens to release the hydraulic fluid to the reservoir 41.

The brake ECU 26 opens and closes the electromagnetically-driven pressure-increasing valves 52 (52FR, 52FL, 52RL and 52RR) and the electromagnetically-driven pressure-decreasing valves 54 (54FR, 54FL, 54RL and 54RR) based on the set target hydraulic pressures (target hydraulic pressure braking forces), and supplies the predetermined hydraulic pressures to the respective wheel cylinders 50FR, 50FL, 50RL and 50RR. In other words, the hydraulic pressures that are supplied to the respective wheel cylinders 50FR, 50FL, 50RL and 50RR are adjusted by changing the opening amounts of the electromagnetically-driven pressure-increasing valves 52 (52FR, 52FL, 52RL and 52RR) and the electromagnetically-driven pressure-decreasing valves 54 (54FR, 54FL, 54RL and 54RR). Then, the brake ECU 26 obtains the wheel cylinder pressures detected by the wheel cylinder pressure sensors, compares these wheel cylinder pressures with the target hydraulic pressures, and adjusts the opening amounts of the valves 52 and 54 based on the results of comparison.

For example, in the case of the wheel cylinder 50FL, the brake ECU 26 compares the wheel cylinder pressure detected by the wheel cylinder pressure sensor 53FL with the target hydraulic pressure. If an additional pressure is required, the brake ECU 26 opens the pressure-increasing valve 52FL with the pressure-decreasing valve 54FL closed. Thus, the hydraulic fluid in the accumulator 46 is supplied to the wheel cylinder 50FL via the hydraulic pressure supply conduit 43, the pressure-increasing valve 52FL, and the hydraulic pressure supply branch conduit 49FL. As a result, the hydraulic pressure in the wheel cylinder 50FL increases and the braking force is increased. On the other hand, if the braking force is too strong and the drive wheels 15 are locked (in the ABS control), or if the wheel cylinder pressure detected by the wheel cylinder pressure sensor 53FL is higher than the target hydraulic pressure, the brake ECU 26 determines that the hydraulic pressure should be decreased, and opens the pressure-decreasing valve 54FL with the pressure-increasing valve 52FL closed. Thus, a portion of the hydraulic fluid that has been supplied to the wheel cylinder 50FL is returned to the reservoir 41 via the pressure-decreasing valve 54FL, the hydraulic pressure discharge branch conduit 51FL, and the hydraulic pressure discharge conduit 42. As a result, the hydraulic pressure applied to the wheel cylinder 50 FL is reduced and the braking force is decreased. If the wheel cylinder pressure detected by the wheel cylinder pressure sensor 53FL after increasing or decreasing the hydraulic pressure substantially matches the target hydraulic pressure, the brake ECU 26 determines that the wheel cylinder pressure needs to be maintained, and closes both the pressure-increasing valve 52FL and the pressure-decreasing valve 54FL. As a result, the flow of hydraulic fluid through the hydraulic pressure supply conduit 49FL at a portion on the wheel cylinder 50FL side with respect to the pressure-increasing valve 52FL and the pressure-decreasing valve 54FL is stopped, and the hydraulic pressure that is supplied to the wheel cylinder 50FL is maintained.

If a malfunction occurs in the hydraulic pressure control unit 25 in the electronic control brake system including this hydraulic brake system, an appropriate braking force allocation is not possible. Therefore, if a malfunction is detected in the hydraulic pressure control unit 25, the brake ECU 26 opens the master cutoff valves 39 and 40 and closes the simulator cut off valve 35, thereby directly introducing the hydraulic pressure generated by the master cylinder 31 into the wheel cylinders 50FR, 50FL, 50RL and 50RR via the hydraulic pressure supply conduits 33 and 34. In this way, the braking operation is ensured.

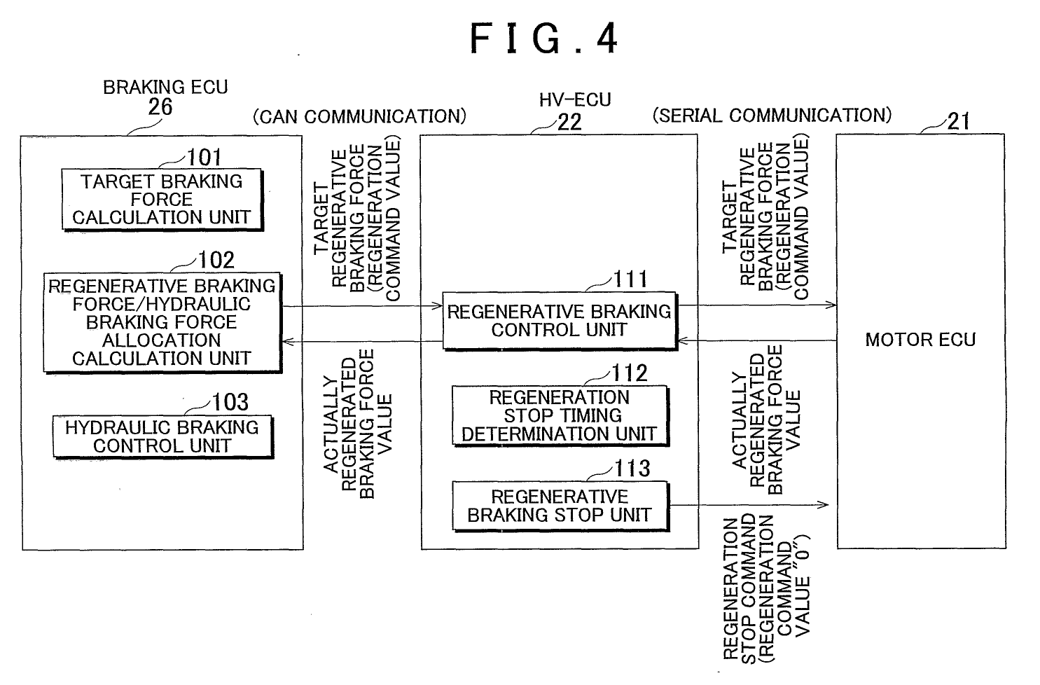

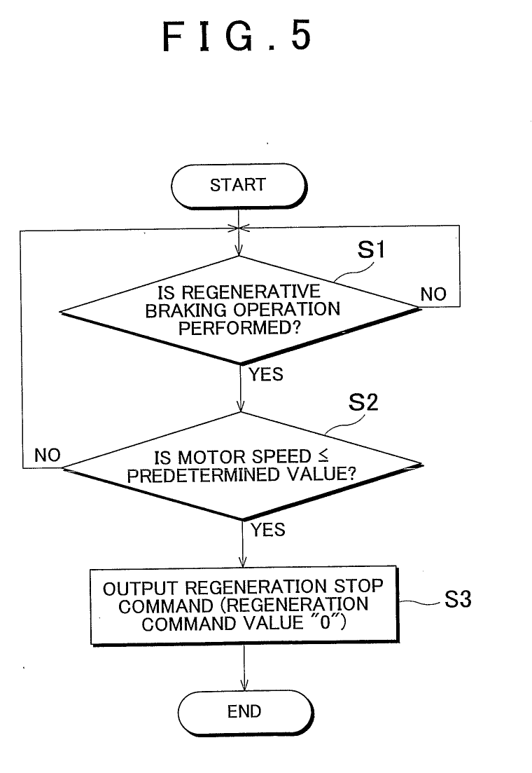

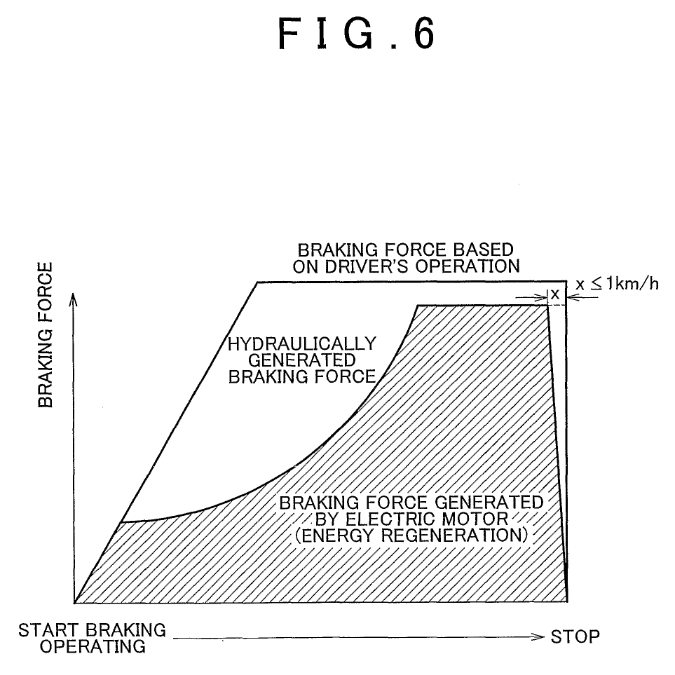

FIG. 4 is a functional block diagram for the brake ECU 26 and the HV-ECU 22, and used to describe the controls executed by the HV-ECU 22 and the brake ECU 26 during a braking operation. FIG. 5 is a flowchart illustrating the control routine executed by the HV-ECU during a braking operation. FIG. 6 is a graph showing the braking force generated by, the hydraulic brake system and the regenerative braking force generated by the electric motor during the braking operation preformed in response to depression of the foot brake of the hybrid vehicle according to the embodiment of the invention. In FIG. 6, the shaded region represents the regenerative braking force generated by the electric motor 12, and the other region represent the braking force generated by the hydraulic brake system.

As described in the description in the related art, in the hybrid vehicle according to the related technology, the HV-ECU 22 and the brake ECU 26 are connected to each other via the CAN. Therefore, the response to the control is slower in the CAN communication than in the serial communication. Accordingly, when the brake ECU 26 is configured to determine whether or not the vehicle is stopping and output a regeneration stop command to the HV-ECU 22 if it is determined that the vehicle is stopping, the HV-ECU 22 receives the regeneration stop command transmitted from the brake ECU 26 via CAN communication and then transmits the regeneration stop command to the motor ECU 21. Therefore, there is a time lag between when the brake ECU 26 determines that the vehicle is stopping and when the HV-ECU 22 outputs the regeneration stop command to the motor ECU 21. Accordingly, there is a possibility that output of a regenerative torque (negative torque) will continue even after the vehicle stops, which may cause an unintentional backward movement of the vehicle. Therefore, according to the embodiment of the invention, the appropriate timing for stopping the regenerative braking operation is determined by the HV-ECU 22, and a regeneration stop command is output to the motor ECU 21. In this way, a slow response to the control for stopping the regenerative braking operation due to the CAN communication is prevented, and the largest possible energy is regenerated without causing backward movement of the vehicle.

As shown in FIG. 4, the CPU of the HV-ECU 22 executes control programs, whereby the HV-ECU 22 functions as a regenerative braking control unit 111 that controls the regenerative braking system based on the target regenerative braking force indicated by a signal received from the brake ECU 26, a regeneration stop timing determination unit 112 that determines the appropriate regeneration stop timing for stopping the regenerative braking operation based on the vehicle driving conditions, and a regenerative braking stop unit 113 that stops the regenerative braking operation when it is determined that the regeneration stop timing determined by the regeneration stop timing determination unit 112 has been reached.

Also, the CPU of the brake ECU 26 executes the braking control programs, whereby the brake ECU 26 functions as a target braking force calculation unit 101 that sets a target braking force based on the pedal operation amount (pedal stroke) that is input from the brake pedal 27 operated by the driver to slow down or stop the vehicle, a regenerative braking force/hydraulic (friction) braking force allocation calculation unit 102 that allocates the target braking force between the target regenerative braking force and the target hydraulic (friction) braking force based on the driving conditions of the vehicle and outputs a signal indicating the allocated target regenerative braking force to the HV-ECU 22, and a hydraulic braking control unit 103 that controls the hydraulic brake system based on the target hydraulic braking force.

The controls executed by the HV-ECU 22 and the brake ECU 26 during the braking operation will be described with reference to FIG. 4 and FIG. 5. As shown in FIG. 4, first, the target braking force calculation unit 101 of the brake ECU 26 calculates the target braking force based on the pedal operation amount (pedal stroke) that is input from the brake pedal 27. The regenerative braking force/hydraulic braking force allocation calculation unit 102 calculates the allocation of the target braking force between the target regenerative braking force and the target hydraulic braking force, and outputs a signal indicating the target regenerative braking force (regeneration command value X (Nm)) to the HV-ECU 22.

In the HV-ECU 22, the regenerative braking control unit 111 receives the signal indicating the target regenerative braking force (regeneration command value X (Nm) from the brake ECU 26, and outputs this signal indicating the target regenerative braking force (regeneration command value X (Nm)) to the motor ECU 21.

The motor ECU 21 has a map that indicates the maximum regenerative braking force with respect to the vehicle speed, and sets the generable regenerative braking force based on the target regenerative braking force indicated by the signal from the HV-ECU according to this map. The motor ECU 21 controls the electric motor 12 based on the target regenerative braking force indicated by the signal from the HV-ECU 22 to cause the electric motor as a generator using the rotation of the drive wheels 15, thereby converting the kinetic (rotational) energy to electric energy which is collected in the battery 19 after passing through the inverter 18 while applying regenerative braking force to decelerate the vehicle. The motor ECU 21 transmits a signal indicating a result value, in other words, a signal indicating the regenerative braking force actually generated by operating the regenerative braking system using the electric motor 12 based on the target regenerative braking force, to the HV-ECU 22.

The regenerative braking control unit 111 of the HV-ECU 22 transmits a signal, indicating the actually generated regenerative braking force received from the motor ECU 21, to the brake ECU 26. The regenerative braking force/hydraulic braking force allocation calculation unit 102 of the brake ECU 26 subtracts the result value indicated by the signal received from the HV-ECU 22, in other words, the actually generated regenerative braking force, from the target braking force, to set the target hydraulic braking force. The hydraulic brake control device 103 sets the target hydraulic pressures, which should be applied to the respective wheel cylinders 50FR, 50FL, 50RL and 50RR based on the target hydraulic braking force, adjusts the opening amounts of the electromagnetically-driven pressure-increasing valves 52 (52FR, 52FL, 52RL and 52RR) and the electromagnetically-driven pressure-decreasing valves 54 (54FR, 54FL, 54RL and 54RR) based on the target hydraulic pressures, and decelerates the vehicle by controlling the hydraulic brakes 24 using the wheel cylinders 50FR, 50FL, 50RL and 50RR.

Furthermore, according to the embodiment of the invention, as shown in FIG. 5, the regeneration stop timing determination unit 112 of the HV-ECU 22 determines whether the rotational speed of the electric motor 12 indicated by a signal received from the rotational speed sensor 12a during the regenerative braking operation (“YES” in step (hereinafter, referred to as “S”) 1) is equal to or lower than a predetermined value (S2). If it is determined that the rotational speed of the electric motor 12 is equal to or lower than the predetermined value (“YES” in S2), the regeneration stop timing determination unit 112 determines that the timing appropriate for stopping the regenerative braking operation has been reached. In this case, if the predetermined value is set to “0”, there is a possibility that it is not accurately determined whether the electric motor 12 is stopped due to a twist that may occur in the drive system. Accordingly, it is preferable to set the predetermined value to a considerably small value (for example 0.3 kph). If such considerably small value is used as the predetermined value, variation in the G force will not occur even if the regenerative braking force is replaced with the braking force generated by the hydraulic brakes 24.

If the regeneration stop timing determination unit 112 determines that the appropriate timing for stopping the regenerative braking operation has been reached (“YES” in S2), the regenerative braking stop unit 113 of the HV-ECU 22 outputs a regeneration stop command (regeneration command value “0”) to the motor ECU 21 (S3). In this way, regenerative braking operation is stopped.

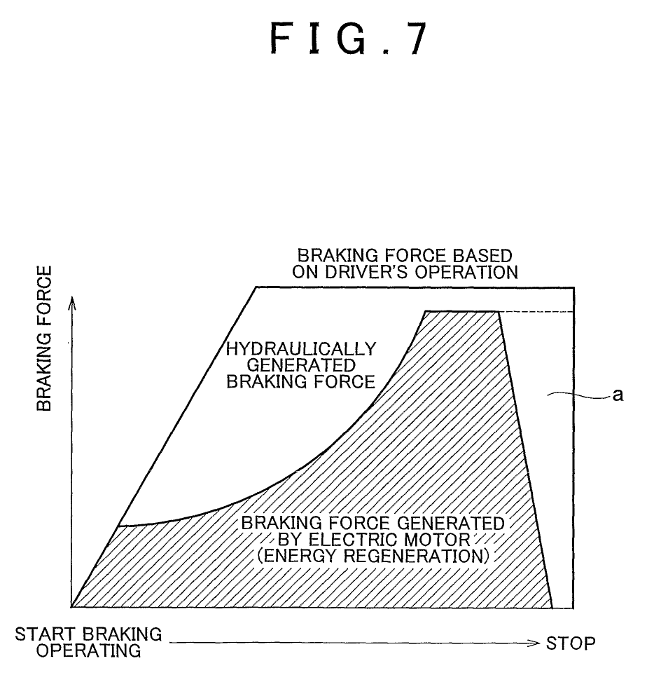

According to the embodiment of the invention, the HV-ECU 22 determines the timing for stopping the regenerative braking operation, and outputs a regeneration stop command to the motor ECU 21. Accordingly, as shown in FIG. 6, the regenerative braking force is available until immediately before the vehicle stops (x≦1 km/h). As compared with the related art shown in FIG. 7, the amount of regenerated energy is increased and the kinetic energy is effectively recovered.

As described above, according to the embodiment of the invention, the brake ECU 26 includes the target braking force calculation unit 101 that sets the target braking force based on the operation amount of an operating member that is operated by a driver to slow down or stop the vehicle, and the regenerative braking force/hydraulic braking force allocation calculation unit 102 that allocates the target braking force between the target regenerative braking force and the target hydraulic braking force based on the driving conditions of the vehicle and outputs a signal indicating the allocated target regenerative braking force to the HV-ECU 22. In addition, the HV-ECU 22 includes the regenerative braking control unit 111 that controls the regenerative braking system based on the target regenerative braking force indicated by the signal received from the brake ECU 26, the regeneration stop timing determination unit 112 that determines the appropriate regeneration stop timing based on the driving conditions of the vehicle, and the regenerative braking stop unit 113 that stops the regenerative braking operation at the regeneration stop timing determined by the regeneration stop timing determination unit 112. Accordingly, the HV-ECU 22 determines the appropriate regeneration stop timing, and outputs a regeneration stop command to the motor ECU 21. In this way, a slow response to the control for stopping the regenerative braking operation due to the CAN communication is prevented, and the largest possible energy is regenerated without causing backward movement of the vehicle.

Furthermore, according to the embodiment of the invention, the regeneration stop timing determination unit 112 determines that the regeneration stop timing has been reached when the rotational speed of the electric motor 12 is equal to or lower than the predetermined value. Accordingly, it is possible to accurately determine whether the vehicle is substantially stopped.

In the embodiment of the invention, the CAN is used as an in-vehicle LAN. However, the invention is not limited to this, and LIN, FlexRay or the like may be used as an in-vehicle LAN. In addition, in the embodiment of the invention, a command to stop the regenerative braking operation is issued when the rotational speed of the electric motor 12 is equal to or lower than the predetermined value. However, the invention is not limited to this, and a command to stop the regenerative braking operation may be issued when the rotational speed of the propeller shaft 28 or rotational speed of the drive wheels 15 is equal to or lower than a predetermined value.

### INDUSTRIAL APPLICABILITY

The automotive braking control apparatus according to the invention may be applied to any type of braking control apparatus for a hybrid vehicle.

1. An automotive braking control apparatus that controls a regenerative braking system and a friction braking system based on an amount by which an operating member is operated by a driver to apply a brake, comprising:
a brake system control unit that controls a brake system; and
a drive system control unit that controls a drive system, wherein
the brake system control unit includes a target braking force calculation unit that sets a target braking force based on the amount by which the operating member is operated by the driver, and a regenerative braking force/friction braking force allocation calculation unit that allocates the target braking force between a target regenerative braking force and a target friction braking force based on driving conditions of a vehicle, and outputs a signal indicating the allocated target regenerative braking force to the drive system control unit, and wherein
the drive system control unit includes a regenerative braking control unit that controls the regenerative braking system based on the target regenerative braking force indicated by the signal received from the brake system control unit, a regeneration stop timing determination unit that determines a regeneration stop timing based on the vehicle driving conditions, and a regenerative braking stop unit that stops the regenerative braking system.

2. The automotive braking control apparatus according to claim 1, wherein the regeneration stop timing determination unit determines that the regeneration stop timing has been reached when a rotational speed of an electric motor is equal to or lower than a predetermined value.

3. The automotive braking control apparatus according to claim 1, wherein the regeneration stop timing determination unit determines that the regeneration stop timing has been reached when a rotational speed of a vehicle propeller shaft or a rotational speed of a driving wheel is equal to or lower than a predetermined value.

4. The automotive braking control apparatus according to claim 2, wherein the regenerative braking stop unit stops the regenerative braking system when the regeneration stop timing determination unit determines that the regeneration stop timing has been reached.

5. The automotive braking control apparatus according to claim 1, wherein the brake system control unit and the drive system control unit are connected to an in-vehicle LAN, and perform data communication using the in-vehicle LAN.

6. The automotive braking control apparatus according to claim 5, wherein any one of CAN, LIN, or FlexRay is used as the in-vehicle LAN.

7. The automotive braking control apparatus according to claim 1, further comprising:
a motor controller that controls an electric motor that is used for the regenerative braking system, wherein
serial connection is established between the motor controller and the drive system control unit.

8. The automotive braking control apparatus according to claim 1, wherein the vehicle is a hybrid vehicle equipped with an engine that outputs torque by burning fuel therein, and an electric motor that outputs torque using electric power supplied thereto.

9. A control method for an automotive braking control apparatus that controls a regenerative braking system and a friction braking system based on an amount by which an operating member is operated by a driver to apply a brake, wherein the automotive braking control apparatus includes: a brake system control unit that controls a brake system; and a drive system control unit that controls a drive system
the control method comprising:
in the brake system control unit,
setting a target braking force based on the amount by which the operating member is operated by the driver; and
allocating the target braking force between a target regenerative braking force and a target friction braking force based on driving conditions of a vehicle and outputting a signal indicating the allocated target regenerative braking force to the drive system control unit, and
in the drive system control unit,
controlling the regenerative braking system based on the target regenerative braking force indicated by the signal received from the brake system control unit;
determining a regeneration stop timing based on the driving conditions of the vehicle; and
stopping the regenerative braking system.

10. The control method for an automotive braking control apparatus according to claim 9, wherein it is determined that the regeneration stop timing has been reached when a rotational speed of an electric motor is equal to or lower than a predetermined value.

11. The control method for an automotive braking control apparatus according to claim 9, wherein it is determined that the regeneration stop timing has been reached when a rotational speed of a vehicle propeller shaft or a rotational speed of a driving wheel is equal to or lower than a predetermined value.

12. The control method for an automotive braking control apparatus according to claim 10, wherein the regenerative braking system is stopped when it is determined that the regeneration stop timing has been reached.

13. The control method for an automotive braking control apparatus according to claim 9, wherein the brake system control unit and the drive system control unit are connected to an in-vehicle LAN, and perform data communication using the in-vehicle LAN.

14. The control method for an automotive braking control apparatus according to claim 13, wherein any one of CAN, LIN, or FlexRay is used as the in-vehicle LAN.

15. The control method for an automotive braking control apparatus according to claim 9, wherein:
the automotive braking control apparatus further includes a motor controller that controls an electric motor used for the regenerative braking system; and
serial connection is established between the motor controller and the drive system control unit.

16. The control method for an automotive braking control apparatus according to claim 9, wherein the vehicle is a hybrid vehicle equipped with an engine that outputs torque by burning fuel therein, and an electric motor that outputs torque using electric power supplied thereto.
